(19) United States
(12) Patent Application Publication
(10) Pub. No.: US 2025/0285328 A1
(43) Pub. Date: Sep. 11, 2025

(54) METHOD AND DEVICE FOR CAMERA CALIBRATION ALGORITHM USING UNBIASED CONIC ESTIMATOR CONSIDERING DISTORTION

(71) Applicant: SEOUL NATIONAL UNIVERSITY R&DB FOUNDATION, Seoul (KR)

(72) Inventors: Ayoung KIM, Seoul (KR); Chaehyeon SONG, Seoul (KR); Jongwoo LIM, Seoul (KR); Myunghwan JEON, Seoul (KR); Jaeho SHIN, Seoul (KR)

(73) Assignee: SEOUL NATIONAL UNIVERSITY R&DB FOUNDATION, Seoul (KR)

(21) Appl. No.: 18/774,088

(22) Filed: Jul. 16, 2024

(30) Foreign Application Priority Data
Mar. 7, 2024 (KR) 10-2024-0032509

(51) Int. Cl. G06T 7/80

(52) U.S. Cl. CPC G06T 7/80

(57) ABSTRACT

The present disclosure relates to a method and device for a camera calibration algorithm using an unbiased conic estimator considering distortion, and may be configured to calculate an ellipse in a normalized coordinate system from a circular pattern in a space, express a center of a distorted ellipse in a camera coordinate system as a linear combination of moments of the ellipse, and perform camera calibration from an image of the circular pattern using the center as a control point.

### CROSS-REFERENCE TO RELATED APPLICATION(S)

This application claims the benefit under 35 USC 119(a) of Korean Patent Application No. 10-2024-0032509, filed with the Korean Intellectual Property Office on Mar. 7, 2024, the disclosure of which is incorporated herein by reference in its entirety.

### BACKGROUND OF THE INVENTION

### Field of the Invention

The present disclosure relates to a method and device for a camera calibration algorithm using an unbiased conic estimator considering distortion.

### Background of the Related Art

Camera calibration is performed using pictures photographing a calibration board of which the numerical values are accurately known. A chessboard (may also be referred to as a checkerboard) or a circular pattern board is mainly used as the calibration board, and the chessboard uses vertices of a square as control points, and the circular pattern board uses the center of an observed circular pattern board as the control point. In the case of the circular pattern board, although accuracy of observing the control point is higher than that of the chessboard board, accuracy of calibration is low as there is no algorithm for accurately estimating the control point when there exists camera distortion.

### SUMMARY OF THE INVENTION

The present disclosure provides a method and device that overcomes the limitations of calibration using an existing circular pattern board by developing an algorithm that accurately estimates the control point of the circular pattern board when there exists a distortion, and exhibits accuracy higher than that of a method using a chessboard board.

The present disclosure provides a method and device for camera calibration algorithm using an unbiased conic estimator considering distortion.

In the present disclosure, a camera calibration method of a computer device may comprise the steps of: calculating an ellipse in a normalized coordinate system from a circular pattern in a space; expressing a center of a distorted ellipse in a camera coordinate system as a linear combination of moments of the ellipse; and performing camera calibration from an image of the circular pattern using the center as a control point.

In the present disclosure, a computer device for camera calibration comprises: a memory; and a processor connected to the memory and configured to execute at least one instruction stored in the memory, and the processor may be configured to calculate an ellipse in a normalized coordinate system from a circular pattern in a space, express a center of a distorted ellipse in a camera coordinate system as a linear combination of moments of the ellipse, and perform camera calibration from an image of the circular pattern using the center as a control point.

In the present disclosure, there is provided a computer program stored in a non-transient computer-readable recording medium to execute a camera calibration method on a computer device, and the camera calibration method may comprise the steps of: calculating an ellipse in a normalized coordinate system from a circular pattern in a space; expressing a center of a distorted ellipse in a camera coordinate system as a linear combination of moments of the ellipse; and performing camera calibration from an image of the circular pattern using the center as a control point.

### BRIEF DESCRIPTION OF THE DRAWINGS

FIG. 1 is a view for explaining the limitations of calibration using a general circular pattern and overcoming the limitations of calibration using a circular pattern according to the present disclosure.

FIG. 2 is a view for explaining image projection between coordinate systems according to the present disclosure.

FIG. 3 is a diagram for explaining moment calculation for an ellipse on a normalized plane according to the present disclosure.

FIG. 4 is a view showing an algorithm for the entire process of an unbiased conic estimator according to the present disclosure.

FIGS. 5A, 5B, 5C, and 5D are views for comparing the calibration algorithm of the prior art and the algorithm of the present disclosure.

FIG. 6 is a view for evaluating the calibration algorithm of the prior art and the algorithm of the present disclosure using a real image.

FIG. 7 is a view showing a computer device according to various embodiments using an unbiased conic estimator according to the present disclosure.

FIG. 8 is a flowchart illustrating a camera calibration method of a computer device according to various embodiments using an unbiased conic estimator according to the present disclosure.

The patent or application file contains at least one drawing executed in color. Copies of this patent or patent application publication with color drawing(s) will be provided by the Office upon request and payment of the necessary fee.

### DETAILED DESCRIPTION OF THE PREFERRED EMBODIMENT

The present disclosure provides a method and device for camera calibration algorithm using an unbiased conic estimator considering distortion. The present disclosure has developed a new methodology for calibrating intrinsic parameters of a camera for a pinhole camera model. Since the camera calibration is a prerequisite procedure required in most cases of analyzing a space using a camera, the present disclosure that has dramatically improved its accuracy may be applied to most application fields that use cameras, such as autonomous driving, robotics, and the like. In the present disclosure, a circular pattern board having at least one circular pattern is used.

Hereinafter, various embodiments of this document are described with reference to the accompanying drawings.

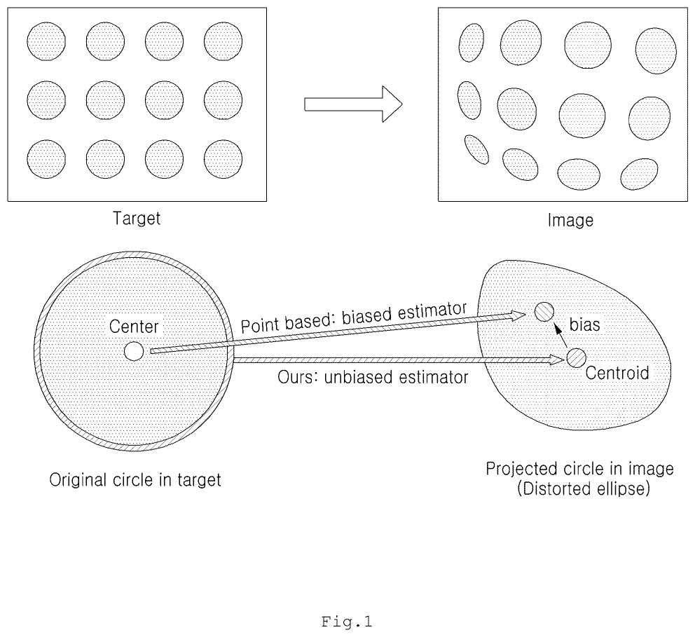

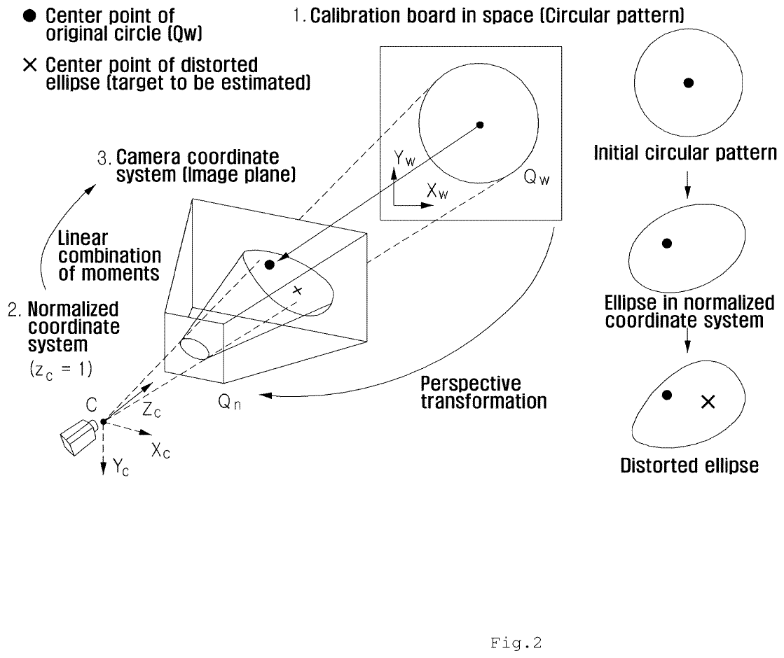

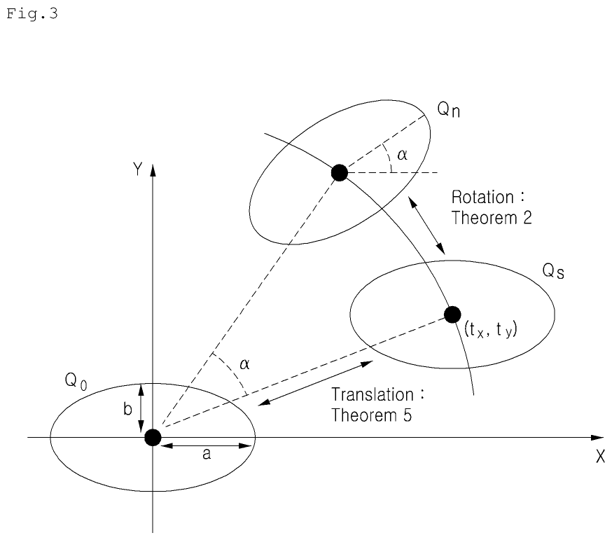

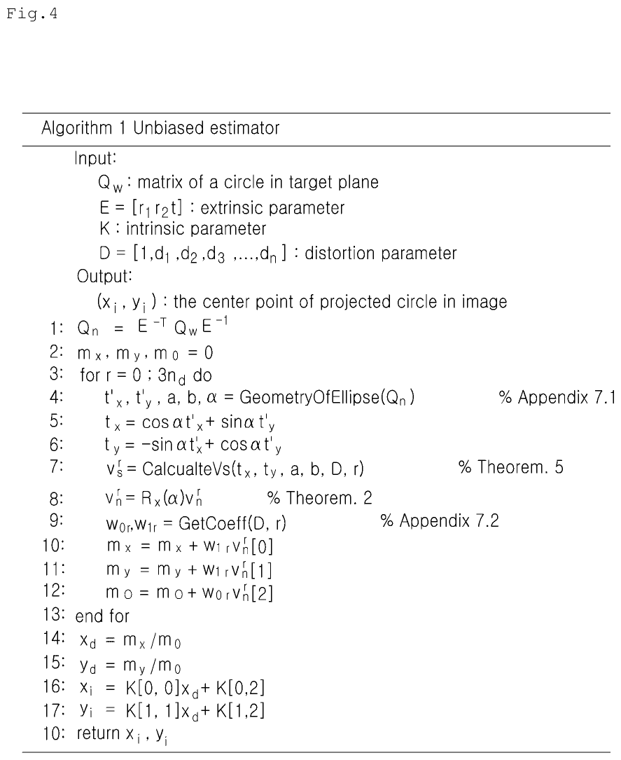

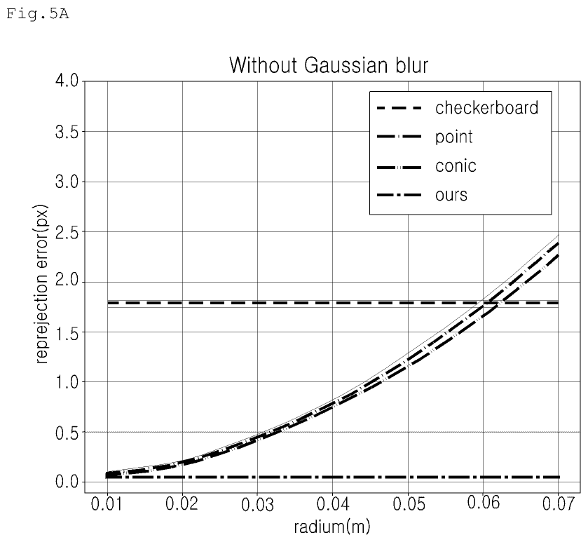

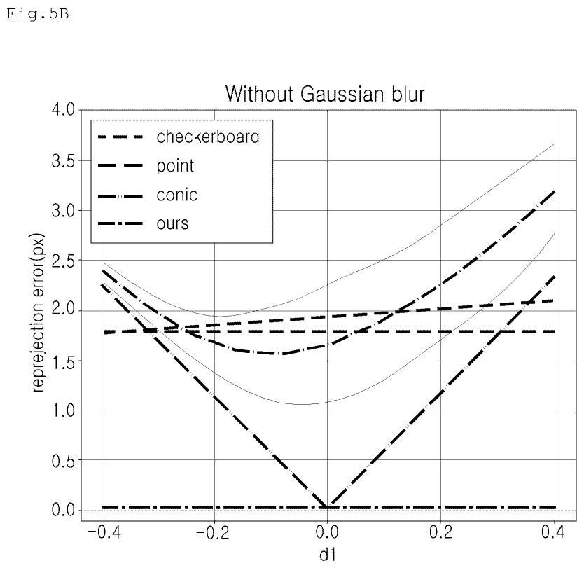

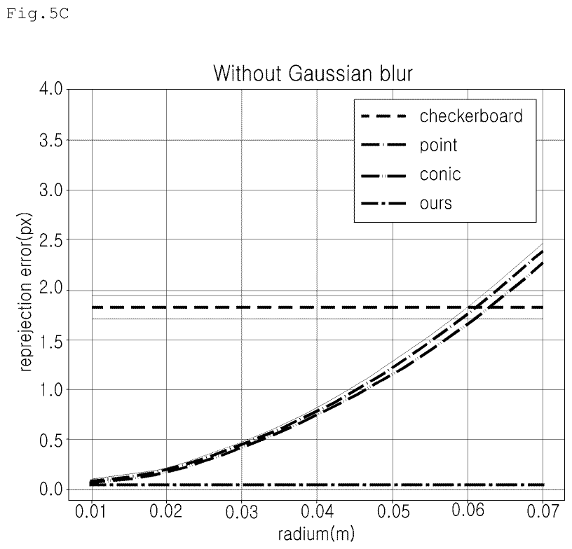

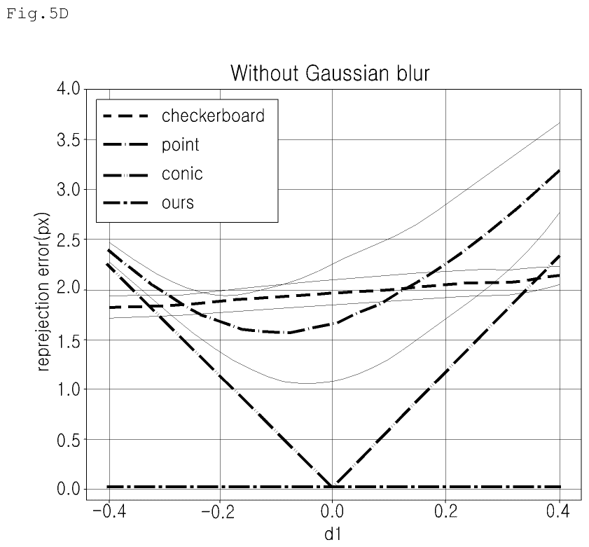

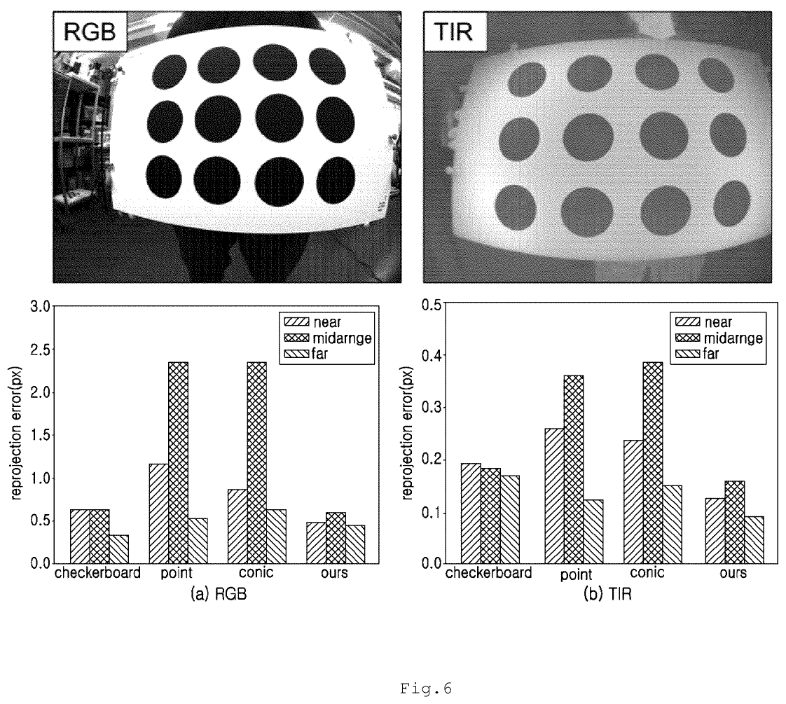

FIG. 1 is a view for explaining the limitations of calibration using a general circular pattern and overcoming the limitations of calibration using a circular pattern according to the present disclosure. FIG. 2 is a view for explaining image projection between coordinate systems according to the present disclosure. FIG. 3 is a diagram for explaining moment calculation for an ellipse on a normalized plane according to the present disclosure. FIG. 4 is a view showing an algorithm for the entire process of an unbiased conic estimator according to the present disclosure. FIGS. 5A, 5B, 5C, and 5D are views for comparing the calibration algorithm of the prior art and the algorithm of the present disclosure. FIG. 6 is a view for evaluating the calibration algorithm of the prior art and the algorithm of the present disclosure using a real image.

### 1. OVERVIEW

Camera calibration is essential to 3D computer vision and vision-based recognition. Particularly, a process of understanding geometry from an image relies on accurate camera calibration, including 3D density reconstruction, visual simultaneous localization and mapping (SLAM), and depth estimation. This fundamental problem has been solved in various ways, and most calibration methods utilize planar targets covered with specific patterns, such as a chessboard or a circular pattern. This approach based on a planar target requires precise measurements and obtains accurate calibration results through an unbiased projection model of control points (i.e., corners of a chessboard or the center of a circular pattern). A lot of documents show researches that have studied obvious advantages and disadvantages of the two patterns. The chessboard guarantees precise (unbiased) estimations in perspective transformation and distortion, but is limited to pixel level detection accuracy. On the other hand, the circular pattern is excellent in achieving sub-pixel level detection accuracy, but may lead to a poor calibration result due to a biased projection model that ignores conic features. This is since that nonlinear lens distortion impairs geometric properties of a circle, making it difficult to estimate the center of a projected circle, as shown in FIG. 1.

The present disclosure overcomes the limitations of the circular pattern by proposing an unbiased conic estimator in a solution of a closed form to deal with distorted biases. Within the scope of general knowledge, this is the first analytic solution that describes projected conic features under radial polynomial distortion. Inspired by the fact that moment representation may describe general distribution transformation under arbitrary polynomial mapping, it has been proved that the property of a distorted conic, such as a center, can be expressed as a linear combination of n-th moments of an undistorted conic. The present disclosure is not limited to only distortion models for pinhole camera calibration. Moreover, it proposes a general and differentiable approach that tracks the conic under an arbitrary nonlinear transformation. This is about an arbitrary nonlinear transformation that can be approximated as a polynomial function.

Through synthetic and real experiments, it is proved that the estimator of the present disclosure is free of bias by investigating the reprojection error with respect to various distortions and the radius of a circular shape with known camera parameters. In addition, the estimator of the present disclosure is also applied to calibration of RGB and thermal imaging (TIR) cameras, with which it is difficult to detect control points due to the boundary blurring effect. As a result, the method of the present disclosure shows excellent performance in the reprojection error and 6D pose method compared to the existing circular pattern-based method and chessboard method. The main contributions of the work of the present disclosure are summarized as follows.
As an unbiased conic estimator considering distortion is developed, virtues of circular patterns with a simple, powerful, and accurate detector are fully exploited. In combination of mathematical elegance and practical ingenuity, the work of the present disclosure completes the missing parts of a conic-based calibration pipeline.
It utilizes the probabilistic concept of moment that has not been attempted before in calibration, and provides general moments of a conic in an analytic form through mathematical derivation and proof. This approach allows design of an unbiased conic estimator for circular patterns.
The unbiased estimator of the present disclosure improves the overall calibration performance as a result of testing on synthetic and real images. Particularly, it shows that the method of the present disclosure provides greatly improved calibration results, especially for TIR images containing blur, noise, and significant distortions of high level. The present disclosure opens the algorithms of the present disclosure to support the communities that use conic functions for calibration.

### 2. RELATED TECHNOLOGIES

Planar pattern and control points. Previously, a calibration method using a planar target with a specific pattern printed thereon is introduced. This planar target should include control points that can be easily and accurately extracted from the pattern. A chessboard pattern comprising black and white squares is considered first, and a circular pattern is introduced thereafter. The chessboard pattern uses corners as control points, while the circular pattern uses the center of a circular pattern projected from an image with a subpixel accuracy. Since the accurate position of control points is important, an interactive method for refining the position of control points is also considered.

Unbiased estimator. To obtain accurate calibration results, both the measurement quality of a control point and the quality of an estimated value are important. In contrast to the chessboard pattern having an unbiased estimator in most cases, it has been proved that a bias is generated when the same estimator is applied to a circular pattern. Specifically, the center point of a circle in the target is not projected to the center point of a projected circle in the image. Several studies have attempted to solve this problem by adopting conic-based transformation. These methods have obtained an unbiased estimator from linear transformation such as perspective transformation. However, the bias generated from distortion is not solved yet since conic characteristics are not preserved under nonlinear transformation. The bias resulting from distortion is an important factor in most cameras. Although a general concept of an unbiased estimator for circular patterns has been presented to solve this problem, an analytic solution for a given integral equation has not been derived.

Methods without control points. An approach that directly uses conic characteristics has been developed at the same time. Early studies are able to obtain images of an absolute conic from a conic equation by utilizing concentric circles. Some studies are focused on spheres having invariant properties. A sphere has a property of always being projected onto a circle and having a radius depending only on the distance between an object and a camera. However, these methods are also affected by distortion bias. This distortion bias destroys all important geometry of conics or spheres. To deal with nonlinear distortion functions, existing works utilize line features that are always straight in an unbiased image. Although intrinsic parameters are not estimated explicitly in this work, recent studies have adopted a solution of a closed form of the intrinsic parameters using line features of undistorted images.

### 3. PRELIMINARIES

### 3.1. Concepts

Vector p∈ [symbol] and matrix Q∈ [symbol] are displayed in bold letters of lowercases and uppercases, and coordinates are included in the index. The present disclosure sets the world coordinate system to be the same as the target frame. Therefore, p_{ω}=(x_{ω}, y_{ω})^{T} is a 2D point in the target plane written in the target coordinate system, and pᵢ is a corresponding point in the image. This target point p_{ω}=(x_{ω},y_{ω})^{T} is projected onto point pₙ on the normalized plane through perspective projection, and then, pₙ is mapped to point pᵢ on the image plane in the camera coordinate system using a distortion and intrinsic matrix. In addition, Q_{ω} is the matrix expression of an ellipse on the target plane, and Qₙ is an ellipse on the normalized plane. Details of these notations and the geometric relationships between the coordinates are described in FIG. 2. The present disclosure uses ˜ for homogeneous vector representation. In addition, \tilde{p}≃\tilde{q} means that the two vectors are identical except the scale.

### 3.2. Matrix Representation of Conic

A conic is a set of points (x, y) that satisfies Equation 1 shown below.

$${ax}^{2} + 2 bxy + {cy}^{2} + 2 dx + 2 ey + f = 0 \qquad [ Equation 1 ]$$

This may also be written in the matrix form of [Equation 2] shown below.

$${x}^{τ} Qx = 0 , Q = ( \begin{matrix}a & b & d \\ b & c & e \\ d & e & f\end{matrix} ) , x = [ \begin{matrix}x \\ y \\ 1\end{matrix} ] \qquad [ Equation 2 ]$$

Symmetric matrix Q is the characteristic matrix of a conic. Generally, a conic comprises an ellipse, parabola, and hyperbola. However, it is concentrated only on the ellipse in the present disclosure since the focus is always on the images of a circle that becomes an ellipse. For a given characteristic matrix Q, the center of an ellipse is calculated as shown in [Equation 3].

$$\tilde{p} = {{Q}^{- 1} [ \begin{matrix}1 & 0 & 1\end{matrix} ]}^{τ} \qquad [ Equation 3 ]$$

### 3.3. Camera Model

By applying a pinhole camera model, 2D point \tilde{p}_{ω} on the target plane is projected onto an image by [Equation 4] to [Equation 9] shown below.

$$K = [ \begin{matrix}{f}_{x} & 0 & {c}_{x} \\ 0 & {f}_{y} & {c}_{y} \\ 0 & 0 & 1\end{matrix} ] \qquad [ Equation 4 ]$$

$${T}_{c ω} = [ \begin{matrix}R & t \\ {0}^{τ} & 1\end{matrix} ] = [ \begin{matrix}{r}_{1} & {r}_{2} & {r}_{3} & t \\ 0 & 0 & 0 & 1\end{matrix} ] \qquad [ Equation 5 ]$$

$${\tilde{p}}_{i} = [ \begin{matrix}u \\ v \\ 1\end{matrix} ] ≃ K [ \begin{matrix}{r}_{1} & {r}_{2} & {r}_{3} & t\end{matrix} ] [ \begin{matrix}{x}_{ω} \\ {y}_{ω} \\ {z}_{ω} \\ 1\end{matrix} ] \qquad [ Equation 6 ]$$

$$≃ K [ \begin{matrix}{r}_{1} & {r}_{2} & t\end{matrix} ] [ \begin{matrix}{x}_{ω} \\ {y}_{ω} \\ 1\end{matrix} ] ( ∵ {z}_{ω} = 0 ) \qquad [ Equation 7 ]$$

$$≃ KE {\tilde{p}}_{ω} ( {\tilde{p}}_{ω} \hat{=} {[ {x}_{ω} , {y}_{ω} , 1 ]}^{τ} ) \qquad [ Equation 8 ]$$

$$≃ K {\tilde{p}}_{n} ≃ H {\tilde{p}}_{ω} \qquad [ Equation 9 ]$$

Here, K is the intrinsic parameter of the camera, E is the extrinsic parameter between target coordinates and camera coordinates, and H is a homography matrix. The above equation fully determines the relation between the target point and the projected point \tilde{p}ₙ on the normalized plane. However, this projected point \tilde{p}ₙ goes through an additional nonlinear transformation (lens distortion) when it is projected onto the image plane. Among the two types of distortions of radial and tangential distortions, only the radial distortion is considered. The radiation distortion is known to be sufficient for most cameras, and is generally modeled as a polynomial function as shown in [Equation 10] to [Equation 13].

$${s}_{n} = {x}_{n}^{2} + {y}_{n}^{2} \qquad [ Equation 10 ]$$

$$k = {\sum }_{i = 0}^{{n}_{d}} {d}_{i} {s}_{n}^{i} ( {d}_{0} = 1 ) \qquad [ Equation 11 ]$$

$${\tilde{p}}_{d} = D ( {\tilde{p}}_{n} ) = {[ {x}_{d} , {y}_{d} , 1 ]}^{τ} = {[ {kx}_{n} , {ky}_{n} , 1 ]}^{τ} \qquad [ Equation 12 ]$$

$${\tilde{p}}_{i} ≃ K {\tilde{p}}_{d} = KD ( {\tilde{p}}_{n} ) = KD ( E {\tilde{p}}_{ω} ) \qquad [ Equation 13 ]$$

Here, d₁ is the distortion parameter, and D is the distortion function. Value n_{d} is the maximum order of the distortion parameter, and it is generally smaller than 4 in conventional calibration methods.

### 4. UNBIASED ESTIMATOR FOR CIRCULAR PATTERNS

### 4.1. Intuition: Situational Approach

The main objective of this section is to provide a thorough mathematical derivation for an unbiased estimator of the control point, which is the center point of a projected circular pattern of an image derived from a target pattern. Tracking the control point under homography transformation is simple. As shown in [Equation 14] and [Equation 15], an ellipse is projected onto another ellipse according to homography transformation H.

$${\tilde{p}}_{f} ≃ H {\tilde{p}}_{i} \qquad [ Equation 14 ]$$

$${Q}_{f} ≃ {H}^{- τ} {Q}_{i} {H}^{- 1} \qquad [ Equation 15 ]$$

The subscript indicates frame f transformed from original frame i. By combining [Equation 3] and [Equation 15], the center of the transformed ellipse is calculated as HQᵢ⁻¹H^{T}(0,0,1)^{T}, and this is not the same as the transformed center point HQᵢ⁻¹(0,0,1)^{T} of the original ellipse. Before applying the method of the present disclosure, several geometric concepts are defined in advance.

Definition 1 (Shape). Shape A_{xy} is a set of points enclosed by a closed curve on the xy-plane. |A_{xy}| is the inner area of the closed curve. Aₖ denotes Aₓ_{ₖ}_{y}_{ₖ}.

Conic features lose their characteristics in nonlinear transformation such as distortion. The present disclosure utilizes the moment theory to construct an unbiased estimator under the distortion. In the probability theory, the (i+j)^{th} moment of random variables X and Y is defined as E[XⁱYⁱ]. Assuming that points of a given shape exist on a uniform distribution, the spatial average corresponds to the expected value of a random variable. The present disclosure defines the (i+j)^{th} moment of a 2D shape in the xy coordinate system.

Definition 2 (moment). For all m,n∈ [symbol] (set of non-negative integers), M_{xy}^{m,n} is defined as the (m+n)^{th} moment of A_{xy}.

$${M}_{xy}^{m , n} = \frac{1}{\vert {A}_{xy} \vert} \int {x}^{m} {y}^{n} {dA}_{xy} \qquad [ Equation 16 ]$$

The first moment factors (M^{1,0} and M^{0,1}) are the center of a shape, and the second-order moment factors (M^{2,0}, M^{1,1} and M^{0,2}) are related to covariance of the shape. Therefore, an ellipse may be described using only the first and second moment factors. The matrix form of the ellipse is x^{T}Qₓ≤0, and the moment form is [M^{1,0}, M^{0,1}, M^{2,0}, M^{1,1}, M^{0,1}]. Each representation has the same five degrees of freedom (DoF).

Theorem 1. When a polynomial D:(x,y)→(x′,y′) having an inverse function is given in domain X, it is assumed that A_{xy}⊂X is transformed to A_{x′y′} by D. For any m,n∈ [symbol] , there exist c_{i,j}∈ [symbol] and p,q∈ [symbol] that establish |A_{x′y′}|M_{x′y′}^{m,n}=|A_{xy}|Σᵢ₌₀^{p}Σⱼ₌₀^{q}c_{i,j}M_{xy}^{i,j}.

Theorem 1 means that for any polynomial mapping, the moment of a transformed shape may always be expressed by a linear combination of moments of the original shape. The number of p and q required varies according to the order of the polynomial function.

### 4.2. Tracking Control Point Under Distortion

Although it is impossible to describe a distorted ellipse in any analytic form, its moment representation always exists according to Theorem 1. Although high-order moments may be used, only the first moment, which is the center point of the shape, is used. This is explained in the next section, Section 4.3.

To examine the shape under distortion mapping, it is assumed that Aₙ is a shape in a plane normalized to a corresponding point (xₙ, yₙ), and A_{d} is a distorted shape corresponding to (x_{d}, y_{d}). The center of the distorted ellipse on the normalized plane is calculated as shown in [Equation 17] to [Equation 21] using Theorem 1.

$${ω}_{0 r} = {\sum }_{i} ( 2 i + 1 ) {d}_{i} {d}_{r - i} \qquad [ Equation 17 ]$$

$${ω}_{1 r} = {\sum }_{i} {\sum }_{j} ( 2 i + 1 ) {d}_{i} {d}_{j} {d}_{r - i - j} \qquad [ Equation 18 ]$$

$$1 = {M}_{d}^{0 , 0} = \frac{\vert {A}_{n} \vert}{\vert {A}_{d} \vert} {\sum }_{r = 0}^{2 {n}_{d}} {ω}_{0 r} [ \frac{1}{\vert {A}_{n} \vert} \int {s}_{n}^{r} {dA}_{n} ] \qquad [ Equation 19 ]$$

$${\overline{x}}_{d} = {M}_{d}^{1 , 0} = \frac{\vert {A}_{n} \vert}{\vert {A}_{d} \vert} {\sum }_{r = 0}^{3 {n}_{d}} {ω}_{1 r} [ \frac{1}{\vert {A}_{n} \vert} \int {x}_{n} {s}_{n}^{r} {dA}_{n} ] \qquad [ Equation 20 ]$$

$${\overline{y}}_{d} = {M}_{d}^{1 , 0} = \frac{\vert {A}_{n} \vert}{\vert {A}_{d} \vert} {\sum }_{r = 0}^{3 {n}_{d}} {ω}_{1 r} [ \frac{1}{\vert {A}_{n} \vert} \int {y}_{n} {s}_{n}^{r} {dA}_{n} ] \qquad [ Equation 21 ]$$

Referring to [Equation 10], Sₙ is defined as xₙ²+yₙ², and [Equation 19] is needed to calculate

$$\frac{\vert {A}_{n} \vert}{\vert {A}_{d} \vert} .$$

2n_{d} and 3n_{d} are for calculating the Riemannian metric.

The center of the projected shape on the image plane may be easily calculated as shown in [Equation 22] and [Equation 23].

$${\overline{x}}_{i} = {f}_{x} {\overline{x}}_{d} + {c}_{x} \qquad [ Equation 22 ]$$

$${\overline{y}}_{i} = {f}_{y} {\overline{y}}_{d} + {c}_{y} \qquad [ Equation 23 ]$$

Therefore, in order to construct an unbiased estimator of [x̅ᵢ,y̅ᵢ], the present disclosure only needs to calculate

$$\frac{1}{\vert {A}_{n} \vert} \int {s}_{n}^{r} {dA}_{n} , \frac{1}{\vert {A}_{n} \vert} \int {x}_{n} {s}_{n}^{r} {dA}_{n} , and \frac{1}{\vert {A}_{n} \vert} \int {y}_{n} {s}_{n}^{r} {dA}_{n}$$

for every integer r from 0 to 3n_{d}, and here, (xₙ,yₙ) is a point in set Aₙ={pₙ|\tilde{p}ₙ^{T}Qₙ\tilde{P}ₙ≤0}. The present disclosure defines these values as vector vₙ^{r} as shown in [Equation 24].

$${v}_{n}^{r} {=}^{△} [ \begin{matrix}\frac{1}{\vert {A}_{n} \vert} \int {x}_{n} {s}_{n}^{r} {dA}_{n} \\ \frac{1}{\vert {A}_{n} \vert} \int {y}_{n} {s}_{n}^{r} {dA}_{n} \\ \frac{1}{\vert {A}_{n} \vert} \int {s}_{n}^{r} {dA}_{n}\end{matrix} ] \qquad [ Equation 24 ]$$

It is not easy to calculate vₙ^{r} directly from an ellipse on a normalized plane. Therefore, this process is divided into two steps as shown in FIG. 3.

Theorem 2. For any 2D rotation transformation R:(xₛ,yₛ)→(xₙ,yₙ), there exists α∈[0,2π].

$${v}_{n}^{r} {=}^{△} [ \begin{matrix}\frac{1}{\vert {A}_{n} \vert} \int {x}_{n} {s}_{n}^{r} {dA}_{n} \\ \frac{1}{\vert {A}_{n} \vert} \int {y}_{n} {s}_{n}^{r} {dA}_{n} \\ \frac{1}{\vert {A}_{n} \vert} \int {s}_{n}^{r} {dA}_{n}\end{matrix} ] \qquad [ Equation 25 ]$$

Theorem 2 implies that when vector vₙ^{r} of an arbitrary unrotated ellipse Aₙ can be calculated, vector vₛ^{r} of an arbitrary ellipse Aₛ can be obtained. Here, the major axis of Aₛ is parallel to the axis of the coordinate system.

Lemma 3. When m,n,i,j∈ [symbol] for

$${I}^{m , n} = \frac{1}{2 π} {\int }_{0}^{2 π} {cos}^{m} θ {sin}^{n} θ d θ ,$$

then

$${I}^{m , n} = \{ \begin{matrix}\frac{( \begin{matrix}2 i + 2 j \\ i + j\end{matrix} ) ( \begin{matrix}i + j \\ i\end{matrix} )}{( \begin{matrix}2 i + 2 j \\ i\end{matrix} ) {2}^{2 i + 2 j}} & if m = 2 i , n = 2 j \\ 0 & otherwise\end{matrix} .$$

Lemma 4. The (m+n)^{th} moment of A₀{(x₀, y₀)|(x₀/a)²+(y₀/b)²≤1}

$${M}_{0}^{m , n} = \frac{{a}^{m} {b}^{n}}{1 + ( m + n ) / 2} {I}^{m , n} .$$

The present disclosure may obtain vₛ^{r} from Theorem 5 using Lemma 3 and Lemma 4. M₀^{m,n} denotes the analytic solution for the (m+n)^{th} moment of the unrotated ellipse located at the origin.

Theorem 5 (solution of vₛ^{r}). When xₛ and yₛ satisfy

$${( \frac{( {x}_{s} - {t}_{x )}}{a} )}^{2} + {( \frac{( {y}_{s} - {t}_{y )}}{b} )}^{2} \leq 1 , \\ {v}_{s}^{r} [ 0 ] = {\sum }_{i = 0}^{r} {\sum }_{j = 0}^{r - i} {M}_{0}^{2 i , 2 j} {\sum }_{k = i}^{r - j} ( \begin{matrix}r \\ k\end{matrix} ) ( \begin{matrix}2 k + 1 \\ 2 i\end{matrix} ) ( \begin{matrix}2 r - 2 k \\ 2 j\end{matrix} ) {t}_{x}^{2 k - 2 i + 1} {t}_{y}^{2 r - 2 k - 2 j} \\ {v}_{s}^{r} [ 1 ] = {\sum }_{i = 0}^{r} {\sum }_{j = 0}^{r - i} {M}_{0}^{2 i , 2 j} {\sum }_{k = i}^{r - j} ( \begin{matrix}n \\ k\end{matrix} ) ( \begin{matrix}2 k \\ 2 i\end{matrix} ) ( \begin{matrix}2 r - 2 k + 1 \\ 2 j\end{matrix} ) {t}_{x}^{2 k - 2 i} {t}_{y}^{2 r - 2 k - 2 j + 1} \\ {v}_{s}^{r} [ 2 ] = {\sum }_{i = 0}^{r} {\sum }_{j = 0}^{r - i} {M}_{0}^{2 i , 2 j} {\sum }_{k = i}^{r - j} ( \begin{matrix}r \\ k\end{matrix} ) ( \begin{matrix}2 k \\ 2 i\end{matrix} ) ( \begin{matrix}2 r - 2 k \\ 2 j\end{matrix} ) {t}_{x}^{2 k - 2 i} {t}_{y}^{2 r - 2 k - 2 j}$$

The present disclosure has reduced the computational cost of calculating vₛ^{r} using dynamic programming. The coefficients comprise products of binomials, and since I^{m,n} is invariant for all conic shapes, as well as circles, it is possible to calculate and store these values in advance. Accordingly, vₛ^{r} is obtained in O(1). vₙ^{r} can be obtained simply by multiplying vₛ^{r} by the rotation matrix according to Theorem 2. The overall process of the unbiased estimator is described as Algorithm 1 of FIG. 4, using the results previously derived to compute [Equation 19] to [Equation 21].

### 4.3. Robustness of First Moment

As mentioned in Section 4.1, a conic is defined by second-order moments. Using the above results, it is possible to calculate the second-order moment of a distorted conic on the image plane. However, the boundary blurring effect easily contaminates high-order moments. For example, when there are some dilations or erosions in the ellipse, the major and minor axis lengths become shorter or longer, while the center of the shape is invariant. For calibration, both the unbiased estimator and accurate measurements are important. Therefore, it is more advantageous to use only the first moment for accurate calibration. Another advantage of the first moment is robustness to image noise. When it is assumed that there are some noises at the boundary points of a shape and the noises follow a normal distribution of which the mean is 0 and variance is σ², the variance of the first moment of the shape is reduced by 1/n. When the boundary points follow the normal distribution, the variance is determined as shown in [Equation 26] and [Equation 27].

$${M}_{X}^{1} = \frac{1}{n} {\sum }_{i} {X}_{i} ( first moment ) \qquad [ Equation 26 ]$$

$$Var ( {M}_{X}^{1} ) = Var ( \frac{1}{n} {\sum }_{i} {X}_{i} ) = \frac{1}{{n}^{2}} Var ( {\sum }_{i} {X}_{i} ) = \frac{n Var ( {X}_{i} )}{{n}^{2}} = \frac{{σ}^{2}}{n} \qquad [ Equation 27 ]$$

This is one of the reasons why circular patterns are more robust to the boundary blurring effect than a chessboard that obtains control points directly from single points. This result will be demonstrated through a set of experiments in Section 5.1.

### 4.4. Calibration Using Unbiased Estimator

The calibration process is divided into two stages. First, the initial value of the intrinsic parameter is set in a closed form assuming that there is no distortion. The initial value is insufficient since distortion parameters are not considered, and calibration is needed through optimization. The optimization process minimizes the reprojection error, and this is the squared difference between the observed position of the control point and the position estimated using an unbiased estimator.

$$K , D = {arg min}_{K , D , {E}^{1 , 2 … n}} {\sum }_{j = 1}^{n} {\sum }_{k = 1}^{m} {‖ {p}_{i}^{jk} - {\hat{p}}_{i}^{jk} ‖}^{2} \qquad [ Equation 28 ]$$

$${\hat{p}}_{i}^{jk} = UnbiasedEstimator ( K , {E}^{j} , {Q}_{ω}^{jk} ) \qquad [ Equation 29 ]$$

Here, pᵢ^{jk} is the k-th control point in the j-th image, and \hat{p}ᵢ^{jk} is the estimated control point corresponding to pᵢ^{jk}. The circle of a target plane corresponding to pᵢ^{jk} is Q_{ω}^{jk}. The above optimization problem is solved using the Ceres Solver.

### 5. RESULTS

### 5.1. Comparison of Estimators

The present disclosure has compared the defined chessboard method and other existing point-based and conic-based estimators as shown in [Equation 30] and [Equation 31] with the unbiased estimator (Algorithm 1 of FIG. 4) of the present disclosure.

$$Point - based : {\hat{\tilde{p}}}_{d} = KD ( {{EQ}_{ω}^{- 1} [ 0 , 0 , 1 ]}^{T} ) \qquad [ Equation 30 ]$$

$$Conic - based : {\hat{\tilde{p}}}_{d} = KD ( {EQ}_{ω}^{- 1} {{E}^{T} [ 0 , 0 , 1 ]}^{T} ) \qquad [ Equation 31 ]$$

Most of existing calibration algorithms use point-based estimators, and this directly match the center of a shape in a distorted image to the center of a circle in a target plane without considering conic geometry. A conic-based estimator compensates for the bias introduced by a perspective transformation. However, the conic-based estimator still obtains a distortion bias. These limitations are well described in FIGS. 5A, 5B, 5C, and 5D. FIGS. 5A and 5B use raw images, and FIGS. 5C and 5D are used after applying Gaussian blur to the raw images. Each data point indicates the average of reprojection errors in fixed 24 scenes, and an error graph is shown together with the standard deviation.

The moment-based unbiased estimator of the present disclosure maintains very small reprojection errors regardless of radius size and distortion. However, the errors of other methods are significant, and the errors of circular pattern methods such as conics and points gradually increase as the radius or distortion increases. Although the amount of distortion does not greatly influence the result of the chessboard method, there are inherent errors caused by inaccurate control point detectors compared to circular patterns. The control point of the chessboard is the corner of the square, and due to the discontinuity of pixels, the corner positions should be approximated by interpolation near the pattern boundaries. On the contrary, the control point of a circular pattern is obtained from the average of thousands of inner points of the circle, and a precise position is obtained at a decimal place.

Since the conic-based and point-based estimators have biases resulting from conic geometry, errors increase as the circle size and distortion increase. The two estimators show slightly different tendencies. The conic-based estimator has a bias generated due to distortion, rather than perspective transformation. Therefore, the reprojection error depends only on the absolute value of the distortion coefficient. Comparatively, the point-based estimator has both perspective and distortion biases. The perspective bias results in a high standard deviation and asymmetry in the error plot.

### 5.2. Calibration Accuracy of Synthetic Images

The present disclosure has evaluated how an unbiased estimator improves calibration performance through experiments on synthetic images. In the present disclosure, the field of view (FOV) is set to about 90 degrees by setting Ground Truth (GT) values for fₓ, f_{y}, cₓ, and c_{y}. Two scenarios of low distortion (d₁=−0.2) and high distortion (d₁=−0.4) are prepared for distortion coefficients. In the latter case, since the distortion function is not an inverse function within a given FOV range, it is transformed to an inverse function by slightly adjusting d₂, and in the analysis of the present disclosure, only dᵢ is evaluated as d₂ is small enough to be ignored. In the present disclosure, 100 images are prepared, and calibration is performed on a set of 30 randomly selected images. This process is repeated 30 times to calculate the average and standard deviation shown in [Table 1].

TABLE 1

| Methods | fx | f_{y} | cₓ | c_{y} | D₁ | #fail |
|---|---|---|---|---|---|---|
| | Low distortion (d₁ = −0.2) | | | | | |
| GT | 600 | 600 | 600 | 450 | −0.2 | |
| checkerboard | 599.8 ± 0.37 | 599.8 ± 0.38 | 600.3 ± 0.37 | 499.9 ± 0.41 | −0.20 ± 0.001 | 0.0 |
| point based | 598.9 ± 0.28 | 598.9 ± 0.28 | 600.0 ± 0.37 | 450.0 ± 0.43 | −0.20 ± 0.001 | 0.0 |
| conic based | 603.5 ± 0.41 | 603.5 ± 0.38 | 600.1 ± 0.37 | 449.8 ± 0.25 | −0.21 ± 0.002 | 0.0 |
| ours | 600.0 ± 0.06 | 600.0 ± 0.06 | 600.0 ± 0.05 | 450.0 ± 0.05 | −0.20 ± 0.000 | 0.0 |
| | Gaussian blur (σ = 2) | | | | | |
| GT | 600 | 600 | 600 | 450 | −0.2 | |
| checkerboard | 598.7 ± 1.99 | 599.1 ± 1.84 | 599.3 ± 2.00 | 450.5 ± 1.52 | −0.20 ± 0.013 | 0.0 |
| point based | 598.7 ± 0.29 | 598.7 ± 0.28 | 600.0 ± 0.32 | 449.0 ± 0.25 | −0.20 ± 0.003 | 0.0 |
| conic based | 603.6 ± 0.47 | 603.6 ± 0.46 | 600.0 ± 0.28 | 449.8 ± 0.18 | −0.21 ± 0.002 | 0.0 |
| ours | 600.0 ± 0.08 | 600.0 ± 0.09 | 600.0 ± 0.08 | 450.0 ± 0.04 | −0.20 ± 0.000 | 0.0 |
| | High distortion (d₁ = −0.4) | | | | | |
| GT | 600 | 600 | 600 | 450 | −0.4 | |
| checkerboard | 600.1 ± 0.22 | 600.2 ± 0.21 | 599.9 ± 0.15 | 450.1 ± 0.12 | −0.40 ± 0.001 | 0.0 |
| point based | 603.1 ± 0.82 | 603.1 ± 0.79 | 599.9 ± 0.53 | 450.3 ± 0.4 | −0.41 ± 0.003 | 0.0 |
| conic based | 606.9 ± 0.80 | 606.9 ± 0.79 | 599.7 ± 0.74 | 450.4 ± 0.51 | −0.41 ± 0.005 | 0.0 |
| ours | 599.9 ± 0.09 | 599.9 ± 0.10 | 600.0 ± 0.03 | 450.0 ± 0.03 | −0.40 ± 0.001 | 0.0 |
| | Gaussian blur (σ = 2) | | | | | |
| GT | 600 | 600 | 600 | 450 | −0.4 | |
| checkerboard | 596.7 ± 2.83 | 597.1 ± 2.70 | 599.6 ± 1.98 | 451.6 ± 2.02 | −0.36 ± 0.026 | 15.8 |
| point based | 603.7 ± 0.65 | 603.3 ± 0.63 | 600.4 ± 0.64 | 450.4 ± 0.31 | −0.41 ± 0.002 | 0.0 |
| conic based | 607.6 ± 1.57 | 607.7 ± 1.57 | 599.9 ± 0.60 | 450.6 ± 0.43 | −0.41 ± 0.004 | 0.0 |
| ours | 599.0 ± 0.07 | 599.9 ± 0.08 | 600.0 ± 0.04 | 450.0 ± 0.03 | −0.40 ± 0.001 | 0.0 |

As a result, the method of the present disclosure consistently obtains the best results in all cases. The approach of the present disclosure benefits from an accurate average and is particularly valuable due to a low variance. Since the estimator of the chessboard pattern is biased, it converges close to GT when there is no noise. However, the calibration results show a significant variance due to inaccurate measurement of control points, and as is confirmed in the experiment of Section 5.1, this tendency further increases when noise is introduced into the image, and performance is lowered as detection of control points fails in many cases.

In the case of the point-based and conic-based methods using a circular pattern, measurement values are accurate and robust. However, due to the biased estimator, they show performance worse than that of the chessboard. As distortion increases, the bias becomes more prominent, and the calibration results are getting worse. The method of the present disclosure that solves these limitations exhibits accuracy and robustness higher than those of the chessboard and other methods. One of important contributions of the present disclosure is to prove the value of circular patterns having abundant information due to algorithmic limitations.

### 5.3. Calibration Accuracy of Real Images

The present disclosure has further evaluated the method of the present disclosure using real images captured by RGB and TIR cameras. Since GT intrinsic parameters of real cameras cannot be found, another evaluation metric is required to extend the experiment to the real world. Instead of directly comparing the intrinsic parameters, distribution of reprojection errors and the relative transformation and rotation value between targets in different scenes are evaluated. Two types of cameras with high distortion are used to emphasize the clear difference between the methods. One is an RGB camera, Trition 5.4 MP, with a resolution of 1200×930. The other is a TIR camera, FLIR A65, with a resolution of 640×512. Sample images of these two cameras are shown in FIG. 6. Since the TIR is limited in recognizing color patterns and distinguishes objects using infrared energy, a printed circuit board (PCB) configured of squares or circles with different heat conductivity is used.

Distribution of reprojection errors. It is expected that the calibration results will be better when the total reprojection error is small and the errors are uniformly distributed. To investigate these two aspects, 24 images are collected at each of close, medium, and far distances. As summarized in FIG. 6, point-based and conic-based methods show high reprojection errors and significant differences in error values between different distances, and this implies that the calculated intrinsic parameters do not consistently explain the projection model at all distances. In contrast thereto, the chessboard method and the method of the present disclosure show excellent performance since the unbiased estimator shows low reprojection errors at all distances. The chessboard method and the method of the present disclosure show similar performance with the RGB camera, and the method of the present disclosure outperforms the checkerboard method with the TIR camera as control points are detected accurately.

6D pose error. To verify the non-projection performance of each method, relative 6-DoF pose errors are investigated. Each camera has captured 20 different scenes, and calibration is conducted with these images. During the calibration, the poses of the target in each scene are also optimized, and these poses are used to evaluate accuracy of the calibration. GT values of relative poses are obtained by the motion capture system of OptiTrack. Tₜ_{ᵢ}^{c} is a SE(3) matrix from the i-th target coordinates to the camera coordinates, and Tₒ_{ᵢ}^{m} is a SE(3) matrix from the i-th object coordinates to the coordinates of the motion capture system. The object frame is the frame attached to the target plane. However, the two frames are not identical since the motion capture system defines another coordinate system for the target. It is impossible to directly evaluate the relative poses without coordinate transformation matrixes Tₜ⁰ and T_{c}^{m}. Therefore, in the present disclosure, the transformation matrixes are calculated first, and the final error is defined as shown in [Equation 32].

$$error = {\sum }_{i = 1}^{n} ‖ {T}_{{o}_{i}}^{m} ⊖ {\hat{T}}_{c}^{m} {{T}_{{t}_{i}}^{c} ( {\hat{T}}_{t}^{o} )}^{- 1} ‖ \qquad [ Equation 32 ]$$

At this point, calculated values \hat{T}_{c}^{m} and \hat{T}ₜ⁰ are used. According to [Table 2] shown below, the method of the present disclosure shows excellent performance overall, and the chessboard method shows low performance in non-projection works despite the low reprojection error.

TABLE 2

| | RGB | | TIR | |
|---|---|---|---|---|
| Methods | Rotation | Translation | Rotation | Translation |
| checkerboard | 0.32° | 2.5 mm | 1.63° | 16.5 mm |
| point-based | 0.36° | 4.2 mm | 0.55° | 3.9 mm |
| conic-based | 0.31° | 2.7 mm | 0.53° | 3.7 mm |
| ours | 0.24° | 2.5 mm | 0.50° | 3.3 mm |

### 6. CONCLUSIONS

The present disclosure introduces n-th moments of a closed form of a circle and proves that the center of a distorted ellipse is expressed by a linear combination of original moments. Based on this result, an unbiased estimator of a circular pattern is developed in a distorted environment for camera calibration. Using this estimator, calibration based on a circular pattern overcomes algorithmic limitations and outperforms chessboard-based calibration.

In summary, the main idea of the present disclosure is to mathematically derive an equation that can estimate the center of a circular pattern. It is largely divided into two stages. First, it is proved that the center of a distorted conic curve can be expressed as the n-th moment of an undistorted conic curve. For the distortion expressed as a polynomial function, the center point of a distorted shape can be expressed as a linear combination of moments of the shape before the distortion. Second, a general solution for the n-th moment of the conic curve is obtained. The moment of the conic curve is derived using various mathematical formulas (partial integration, trigonometric formulas). Aₙ unbiased estimator is developed using the two core techniques described above, and calibration of high accuracy is possible using the estimator.

The present disclosure shows that the center of a deformed conic curve may be expressed as the moment of a conic curve before deformation under general polynomial mapping. Through this, unlike the existing techniques, it is possible to accurately estimate the center of a circular pattern observed in an image without an error. This has dramatically increased accuracy of estimating intrinsic parameters of a camera.

The present disclosure shows the possibility of estimating an average value of Gaussian distribution, which is a probability distribution expressed as a 2D matrix like a conic curve, from an arbitrary polynomial transformation. This advantage may be used in various fields that perform probabilistic spatial recognition using Gaussian distribution.

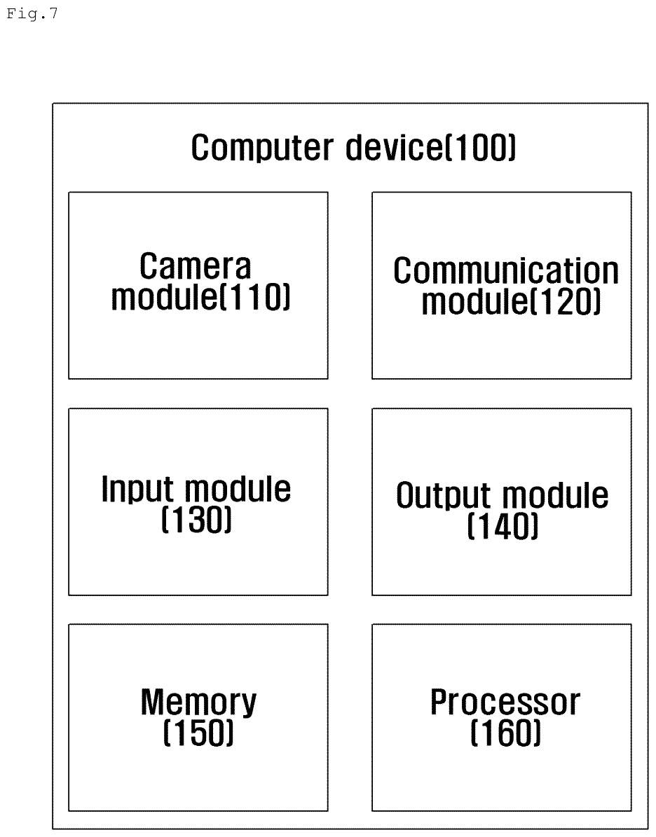

FIG. 7 is a view showing a computer device 100 according to various embodiments using an unbiased conic estimator according to the present disclosure.

Referring to FIG. 7, the computer device 100 may be configured to perform camera calibration using the unbiased conic estimator described above. The computer device 100 may include at least one among a camera module 110, a communication module 120, an input module 130, a display module 140, a memory 150, and a processor 160. In some embodiments, at least one of the components of the computer device 100 may be omitted. In some embodiments, at least one other component may be added to the computer device 100.

In the computer device 100, the camera module 110 may capture images. In some embodiments, the camera module 110 may include at least any one among a lens, an image sensor, an image signal processor, and a flash unit. Here, the image may include at least one among a still image and a moving image. At this point, the camera module 110 may be implemented as a pinhole camera module, but it is not limited thereto. That is, the camera module 110 may be implemented as various camera modules, as well as the pinhole camera module.

In the computer device 100, the communication module 120 may perform communication with an external device (not shown). The communication module 120 may establish a communication channel between the computer device 100 and the external device and perform communication with the external device through the communication channel. The communication module 120 may include at least any one among a wired communication module and a wireless communication module. For example, the wireless communication module may perform communication with an external device through at least any one among a long-distance communication network and a local area communication network.

The input module 130 may input commands to be used in at least one component of the computer device 100. The input module 130 may include at least any one among an input unit configured to allow a user to directly input commands or data into the computer device 100, and a sensor unit configured to detect surrounding environments and generate data. For example, the input unit may include at least any one among a microphone, a mouse, and a keyboard. In some embodiments, the input unit may include at least one among a touch circuit set to sense touches and a sensor circuit set to measure intensity of a force generated by the touch.

The display module 140 may visually output information to the outside of the computer device 100. For example, the display module 140 may include at least any one among a display, a hologram device, and a projector. In some embodiments, the display module 140 may be combined with at least one among the touch circuit and the sensor circuit of the input module 130 to be implemented as a touch screen.

The memory 150 may store various data used by at least one component of the computer device 100. For example, the memory 150 may include at least any one among volatile memory and non-volatile memory. The data may include input data or output data for a program or instructions related thereto. The program may be stored as software in the memory 150 and may include at least any one among the operating system, middleware, and applications.

The processor 160 may execute a program in the memory 150 to control at least one component of the computer device 100 and perform data processing or operation. In various embodiments, the processor 160 may be configured to include the unbiased conic estimator described above and perform camera calibration using the same. At this point, the processor 160 may perform camera calibration on a pinhole camera model, but it is not limited thereto. The processor 160 may perform camera calibration for various camera models, as well as the pinhole camera model. This can be explained with reference to FIG. 2.

Specifically, the processor 160 may convert a circle in a space into a conic curve in the camera coordinate system using multidimensional geometry. A corresponding conic curve may be projected in the shape of an ellipse in a normalized coordinate system. Then, the processor 160 may analytically obtain the n-th moment value of the ellipse in the normalized coordinate system using trigonometric formulas, partial integration, and the like. The center of an ellipse distorted due to radial distortion may be expressed as a linear combination of moments of the ellipse before distortion using the Riemann metric. That is, the processor 160 may accurately express the center of a distorted ellipse using multidimensional geometry knowledge and a general solution for the n-th moment of the ellipse.

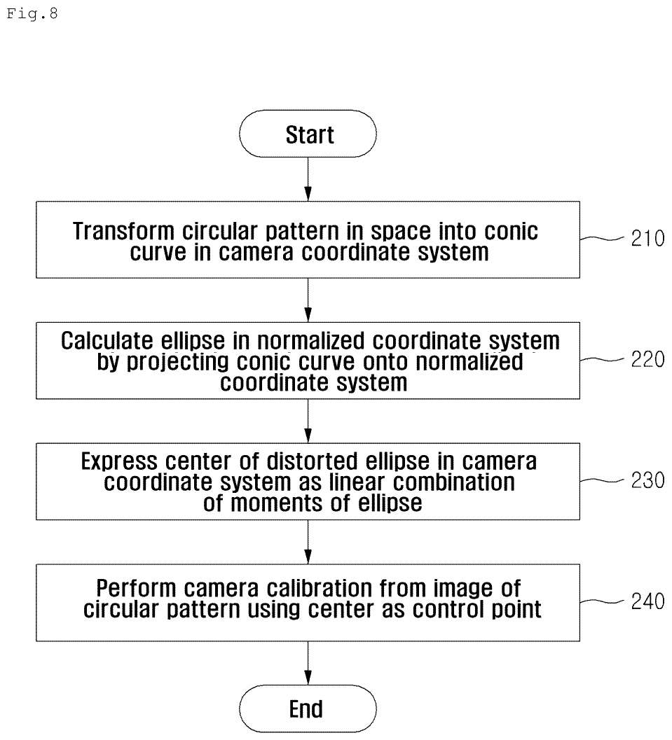

FIG. 8 is a flowchart illustrating a camera calibration method of a computer device 100 according to various embodiments using an unbiased conic estimator according to the present disclosure.

Referring to FIG. 8 together with FIGS. 2 and 7, at steps 210 and 220, the processor 160 may calculate an ellipse in a normalized coordinate system from a circular pattern in the space. Specifically, the processor 160 may transform the circular pattern in the space into a conic curve in the camera coordinate system at step 210. Then, the processor 160 may calculate the ellipse in the normalized coordinate system by projecting the conic curve onto the normalized coordinate system at step 220. In addition, the processor 160 may calculate the ellipse using the matrix for the circular pattern and extrinsic parameters between the target coordinates for the space and the camera coordinate system (see FIG. 4).

Next, at step 230, the processor 160 may express the center of the distorted ellipse in the camera coordinate system as a linear combination of the moments of the ellipse in the normalized coordinate system. Here, the distorted ellipse may be distorted by radial distortion. At this point, the moments are n-th moments, and here, n may be an integer equal to or greater than 1. Preferably, the moments may be first moments. For example, the processor 160 may express the center as a linear combination of moments using the Riemann metric. In addition, the processor 160 may express the center of the distorted ellipse using the distortion parameter for the camera coordinate system and intrinsic parameters of the camera, i.e., the camera module 110.

Next, at step 240, the processor 160 may perform camera calibration from the image of the circular pattern using the center of the distorted ellipse as a control point. In this way, the processor 160 may perform camera calibration for the camera module 110. At this point, the processor 160 may correct the intrinsic parameters of the camera, i.e., the camera module 110.

According to the present disclosure, in performing camera calibration using a circular pattern board, it is possible to accurately estimate control points from a circular pattern board although there exist camera distortions. This may lead to greatly improving the accuracy of camera calibration compared to other camera calibrations, such as camera calibration using a chessboard.

The device described above may be implemented as hardware components, software components, and/or a combination of hardware components and software components. For example, the devices and components described in the embodiments may be implemented using one or more general-purpose or special-purpose computers, such as a processor, a controller, an arithmetic logic unit (ALU), a digital signal processor, a microcomputer, a field programmable gate array (FPGA), a programmable logic unit (PLU), a microprocessor, and any other device capable of executing and responding to instructions. A processing device may execute the operating system (OS) and one or more software applications executed on the operating system. In addition, the processing device may access, store, manipulate, process, and generate data in response to execution of the software. Although there are cases of describing that a single processing device is used for easy understanding, those skilled in the art may understand that the processing device includes a plurality of processing elements and/or processing elements of a plurality of types. For example, the processing device may include a plurality of processors or one processor and one controller. In addition, other processing configurations, such as parallel processors, are possible.

The software may include computer programs, codes, instructions, or a combination of one or more of these, and may configure processing units to operate as desired or may command the processing units independently or collectively. The software and/or data may be embodied in any type of machine, component, physical device, or computer storage medium or device to be interpreted by the processing device or to provide instructions or data to the processing device. The software may be distributed to computer systems connected through a network to be stored or executed in a distributed manner. The software and data may be stored in one or more computer-readable recording media.

Methods according to various embodiments may be implemented in the form of program instructions that can be executed through various computer means and recorded in a computer-readable medium. At this point, the medium may continuously store programs that can be executed by a computer, or temporarily store the programs to execute or download. In addition, the medium may be a variety of recording or storage means in the form of a single piece of hardware or a combination of several pieces of hardware, and is not limited to a medium directly connected to a computer system, but may also be distributed on a network in a distributed manner. Examples of the medium may be those configured to store program instructions, including magnetic media such as hard disks, floppy disks, and magnetic tapes, optical recording media such as CD-ROMs and DVDs, magneto-optical media such as floptical disks, ROM, RAM, flash memory, and the like. In addition, other examples of the medium include various recording media or storage media managed by app stores that distribute applications, or various other sites, servers, or the like that supply or distribute software.

Various embodiments of this document and terms used herein are not intended to limit the techniques described in this document to specific embodiments, and should be understood to include various changes, equivalents, and/or substitutes of the corresponding embodiments. In relation to the description of drawings, similar reference numerals may be used for similar components. Singular expressions may include plural expressions, unless the context clearly dictates otherwise. In this document, expressions such as “A or B”, “at least one among A and/or B”, “A, B or C”, or “at least one among A, B and/or C” may include all possible combinations of items listed together. Expressions such as “a first”, “a second”, “the first”, “the second”, and the like may modify corresponding components regardless of the order or importance, and are used only to distinguish one component from another and do not limit corresponding components. When a component (e.g., a first component) is mentioned to be “(functionally or communicatively) connected” or “coupled” to another component (e.g., a second component), the component may be connected to another component directly or through still another component (e.g., a third component).

The term “module” used in this document includes units configured of hardware, software, or firmware, and may be interchangeably used together with the terms such as logic, logic blocks, parts, circuits, and the like. The module may be an integrated part, a minimum unit that performs one or more functions, or a part thereof. For example, the module may be configured as an application-specific integrated circuit (ASIC).

According to various embodiments, each component (e.g., module or program) among the components described above may include a single entity or a plurality of entities. According to various embodiments, one or more of the components or steps described above may be omitted, or one or more other components or steps may be added. In substitution or addition, a plurality of components (e.g., modules or programs) may be integrated into a single component. In this case, the integrated component may perform one or more functions of each of the plurality of components in a manner the same as or similar to those performed by a corresponding component of the plurality of components prior to integration. According to various embodiments, the steps performed by the modules, programs, or other components may be executed sequentially, in parallel, iteratively, or heuristically, or one or more of the steps may be executed in a different order or omitted, or one or more other steps may be added.

According to the present disclosure, in performing camera calibration using a circular pattern board, it is possible to accurately estimate control points from a circular pattern board although there exist camera distortions. This may lead to greatly improving the accuracy of camera calibration compared to other camera calibrations, such as camera calibration using a chessboard.

What is claimed is:

1. A camera calibration method of a computer device, the method comprising the steps of:
calculating an ellipse in a normalized coordinate system from a circular pattern in a space;
expressing a center of a distorted ellipse in a camera coordinate system as a linear combination of moments of the ellipse; and
performing camera calibration from an image of the circular pattern using the center as a control point.

2. The method according to claim 1, wherein the step of calculating an ellipse includes the steps of:
transforming the circular pattern in the space into a conic curve in the camera coordinate system; and
calculating the ellipse in the normalized coordinate system by projecting the conic curve onto the normalized coordinate system.

3. The method according to claim 1, wherein the moments are n-th moments, and here, n is an integer equal to or greater than 1.

4. The method according to claim 1, wherein the moments are first moments.

5. The method according to claim 1, applied to a pinhole camera model.

6. The method according to claim 1, wherein the step of expressing a center of a distorted ellipse includes the step of expressing the center as the linear combination of the moments using a Riemann metric.

7. The method according to claim 1, wherein the distorted ellipse is distorted by radial distortion.

8. The method according to claim 1, wherein the step of calculating an ellipse includes the step of calculating the ellipse using a matrix for the circular pattern and extrinsic parameters between target coordinates for the space and the camera coordinate system, and the step of expressing a center of a distorted ellipse includes the step of expressing the center of the distorted ellipse using a distortion parameter for the camera coordinate system and an intrinsic parameter of the camera.

9. A computer device for camera calibration, the computer device comprising:
a memory; and
a processor connected to the memory and configured to execute at least one instruction stored in the memory, wherein the processor is configured to calculate an ellipse in a normalized coordinate system from a circular pattern in a space, express a center of a distorted ellipse in a camera coordinate system as a linear combination of moments of the ellipse, and perform camera calibration from an image of the circular pattern using the center as a control point.

10. The computer device according to claim 9, wherein the processor is configured to transform the circular pattern in the space into a conic curve in the camera coordinate system, and calculate the ellipse in the normalized coordinate system by projecting the conic curve onto the normalized coordinate system.

11. The computer device according to claim 9, wherein the moments are first moments.

12. The computer device according to claim 9, further comprising a camera module connected to the processor, configured to capture images, and implemented as a pinhole camera model, wherein the processor is configured to perform the camera calibration for the camera module.

13. The computer device according to claim 9, wherein the processor is configured to express the center as the linear combination of the moments using a Riemann metric.

14. The computer device according to claim 9, wherein the distorted ellipse is distorted by radial distortion.

15. A computer program stored in a non-transient computer-readable recording medium to execute a camera calibration method on a computer device, wherein
the camera calibration method comprises the steps of:
calculating an ellipse in a normalized coordinate system from a circular pattern in a space;
expressing a center of a distorted ellipse in a camera coordinate system as a linear combination of moments of the ellipse; and
performing camera calibration from an image of the circular pattern using the center as a control point.
